(19) United States
(12) Patent Application Publication
(10) Pub. No.: US 2022/0397179 A1
(43) Pub. Date: Dec. 15, 2022

(54) Active Vibration or Sound Absorption Method with Virtual Resonators Exclusively using Sensing Coil's Current and Voltage

(71) Applicant: Baisheng Yu, Erie, PA (US)

(72) Inventor: Baisheng Yu, Erie, PA (US)

(21) Appl. No.: 17/340,007

(22) Filed: Jun. 5, 2021

(51) Int. Cl. F16F 15/03; F16F 7/10

(52) U.S. Cl. CPC F16F 15/03; F16F 7/1011

(57) ABSTRACT

The invention discloses an active vibration or sound absorption method with virtual resonators exclusively using sensing electromagnetic coil's current and voltage. The invention includes an absorption actuator, a sensing module of coil's current and voltage, an absorption controller, and a driving module. The method controls the coil current's phase to be orthogonal to the actuator velocity's phase, to adjust the resonant frequency of the actuator, such that the signal to be absorbed causes a resonance in the actuator. In this way, a virtual resonator is formed. Moreover, one actuator can generate multiple virtual resonators simultaneously to absorb energy of multiple signals with different frequencies, and the resonant frequency and its damping ratio for each virtual resonator can be adjusted independently.

### TECHNICAL FIELD

The invention is related, in general, to the field of active sound or vibration absorption and active control of sound or vibration suppression.

### BACKGROUND OF THE INVENTION

All kinds of sound or vibration absorbers or attenuation suppressors are widely used in various engineering practices. However, there is a lack of high-quality sound or vibration absorbers or attenuation suppressors with simple structures, excellent performance, and stable convergence for multiple frequencies and varying frequencies. This patent precisely meets this demand.

### SUMMARY OF THE INVENTION

The patent discloses a method which adjusts a resonant frequency of the actuator by controlling the actuator's coil current, such that the resonant frequency is consistent with the frequency of the signal to be absorbed. As a result, the signal to be absorbed causes resonance in the actuator, and the resonant cavity is realized virtually. In this way, the signal energy to be absorbed is collected and absorbed by the virtual resonant cavity. Moreover, a damping ratio of the virtual resonant cavity can also be adjusted independently. In addition, the absorption method with the virtual resonators uses an adaptive control algorithm, to actively absorb signal energy with multiple frequencies and frequencies that can be perturbed, based only on the measured coil current's signal and coil voltage's signal. The method is composed of an absorption's actuator, a sensing module of the coil current and voltage, an absorption's controller, and a driving module. The absorption's actuator faces the propagation's direction of the signal to be absorbed, and the sensing module of the coil current and voltage feeds the measured coil current and voltage to the controller. Meanwhile, the absorption's controller outputs a control signal amplified by the driving module to drive the coil of the actuator. Generally speaking, an absorbed source signal usually contains multiple frequency harmonics, and each frequency harmonic which needs to be absorbed corresponds to a virtual resonator. This method is to decompose the absorbed source signal into multiple single-frequency signals, and each of them corresponding to a virtual resonator, and each resonant frequency and damping ratio of the virtual resonator are adjusted according to each decomposed single-frequency, respectively. Finally, each individually controlled output is superimposed and sent to the driving module. Thus, the controller performs adaptive algorithm control on multiple frequencies and variable frequencies for absorption signals. As a result, the energy of the signal to be absorbed will be collected by the virtual resonator and converted into electromagnetic energy to be stored, while mechanical energy to be lost. In this way, the expected function of absorbing signal energy is implemented.

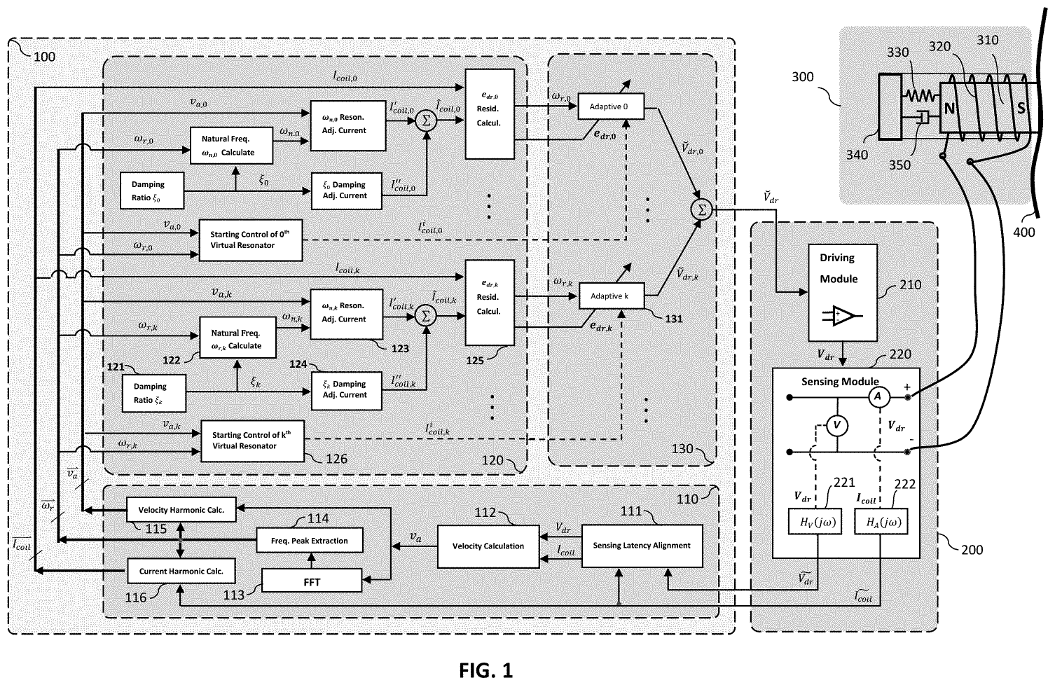

FIG. 1 describes, in detail, the working principle and structural block diagram of the method. First, the controller 100 is connected to the driving module 210 and the sensing module of current and voltage 220. The sensing module of current and voltage 220 measures the coil current and voltage's signals amplified by the driving module 210 configured to drive the absorption's actuator 300, and the measured results are fed back to the controller 100; in addition, the controller 100 includes a calculation module of absorption harmonic 110, calculation module of adjustment residual 120, and an adaptive control module 130; the actuator 300 includes a magnet 310 and a coil of wire 320, an equivalent spring 330, an equivalent mass 340 and an equivalent damping 350. The drawings contain reference marks description and reference variables description.

A theoretical derivation of energy absorption method with virtual resonators and an adaptive control algorithm of the absorption method are presented as below.

1. Energy Absorption Method with Virtual Resonators

The motion equation of moving part of the actuator is:

$$( {m}_{a} S + {c}_{a} + \frac{{k}_{a}}{S} ) {v}_{a} ( s ) = {F}_{e} ( s ) + {F}_{p} ( s )$$

The electromagnetic force caused by the coil current is divided into two parts. One part is used to adjust the resonant frequency of the moving part of the actuator, represented by I′_{coil}; the other part is used to adjust the resonant damping ratio of the moving part of the actuator, expressed by I″_{coil}. It is expressed as:

$${F}_{e} = {C}_{e} Bl \cdot {I}_{coil} ( s ) = {C}_{e} Bl \cdot ( {I}_{coil}^{′} ( s ) + {I}_{coil}^{″} ( s ) )$$

$$( {m}_{a} S - \frac{{C}_{e} Bl}{S \cdot {v}_{a} ( s )} {I}_{coil}^{′} ( s ) \cdot S + {c}_{a} - \frac{{C}_{e} Bl}{{v}_{a} ( s )} {I}_{coil}^{″} ( s ) + \frac{{k}_{a}}{S} ) {v}_{a} ( s ) = {F}_{p} ( s )$$

Let's define

$$( {m}_{a}^{′} S + {c}_{a}^{′} + \frac{{k}_{a}}{S} ) {v}_{a} ( s ) = {F}_{p} ( s )$$

$$( {m}_{a} S + {c}_{a}^{′} + \frac{{k}_{a}^{′}}{S} ) {v}_{a} ( s ) = {F}_{p} ( s )$$

wherein

$${m}_{a}^{′} = {m}_{a} - \frac{{Δ}^{′}}{S} \\ {c}_{a}^{′} = {c}_{a} - {Δ}^{″} \\ {k}_{a}^{′} = {k}_{a} - {Δ}^{′} S \\ {Δ}^{′} = \frac{{C}_{e} Bl}{{v}_{a} ( s )} {I}_{coil}^{′} ( s ) \\ {Δ}^{″} = \frac{{C}_{e} Bl}{{v}_{a} ( s )} {I}_{coil}^{″} ( s )$$

Assuming the phase of I′_{coil} is orthogonal to the phase of νₐ, so m′ₐ or k′ₐ is real, then the natural frequency of the actuator after adjustment is:

$${( {ω}_{n} )}^{2} = \frac{{k}_{a}}{{m}_{a} - \vert {Δ}^{′} \vert / {ω}_{n}} = \frac{{k}_{a} + \vert {Δ}^{′} \vert {ω}_{n}}{{m}_{a}}$$

wherein

$$\vert {Δ}^{′} \vert = {m}_{a} {ω}_{n} - \frac{{k}_{a}}{{ω}_{n}}$$

Assuming again that I″_{coil} and νₐ are in phase or opposite phase, then c′ₐ is real, the resonant damping ratio of the actuator is:

$$ξ = \frac{{c}_{a}^{′}}{{c}_{a , c}^{′}} = \frac{{c}_{a}^{′}}{2 \sqrt{{k}_{a} {m}_{a}^{′}}} = \frac{{c}_{a} - {Δ}^{″}}{2 \sqrt{{k}_{a} {m}_{a}^{′}}}$$

wherein

Δ″=cₐ−2ξ\sqrt{kₐm′ₐ}

The resonant angular frequency of the moving part of the actuator is:

ωᵣ=ωₙ\sqrt{1−2ξ²}

The expected regulation current for the resonant frequency ωₙ is:

$${\hat{I}}_{coil}^{′} = \frac{{v}_{a}}{{C}_{e} Bl} ( {m}_{a} {ω}_{n} - \frac{{k}_{a}}{{ω}_{n}} ) \cdot {e}^{j {ω}_{n}}$$

The expected regulation current for the resonant damping ratio ξ is:

$${\hat{I}}_{coil}^{″} = \frac{{v}_{a}}{{C}_{e} Bl} ( {c}_{a} - 2 ξ \sqrt{{k}_{a} ( {m}_{a} - \vert {Δ}^{′} \vert / {ω}_{n} )} )$$

The expected total coil regulation current is:

Î_{coil}=Î′_{coil}+Î″_{coil}

The expected coil regulation voltage is:

\hat{V}_{dr}=C_{d}Bl·νₐ+Î_{coil}(R_{c}+SL_{c})

Since the velocity of the actuator cannot be changed suddenly, the residual of the regulating voltage is:

e_{dr}=\hat{V}_{dr}−V_{dr}=(Î_{coil}−I_{coil})(R_{c}+SL_{c})

For the case where a signal to be absorbed contains multiple frequency harmonic components, according to the principle of superposition, each absorption frequency corresponds to a virtual resonator, and various variables related to the virtual resonator are also decomposed into corresponding harmonic components, which are expressed as follows:

Fₚ=ΣₖF_{p,k}

νₐ=ₖν_{a,k}

\hat{V}_{dr}=Σₖ\hat{V}_{dr,k}

Î_{coil}=ΣₖÎ_{coil,k}

Î′_{coil}=ΣₖÎ′_{coil,k}

Î″_{coil}=ΣₖÎ″_{coil,k}

In this way, the adjusted voltage residual corresponding to the k^{th} resonant frequency ω_{r,k} is:

e_{dr,k}=\hat{V}_{dr,k}−V_{dr,k}=(Î_{coil,k}−I_{coil,k})(R_{c}+SL_{c})

2. Adaptive absorption control algorithm

Defining the sensing latency relationship for the coil voltage and current as:

[symbol]

=e^{jφ}^{_{dr,k}}^{^{sen}}·V_{dr,k}

[symbol]

=e^{jφ}^{_{coil,k}}^{^{sen}}·I_{coil,k}

To adjust the latency for each frequency harmonic component to satisfy:

φ_{dr,k}^{sen}−φ_{coil,k}^{sen}=φ_{dr,k}^{adj}−φ_{coil,k}^{adj}=Δtₛₑₙₛₑ/ω_{r,k}

where Δtₛₑₙₛₑ is a difference between the measured voltage latency and the measured current latency.

Defining amplitude-phase relationship for the driving module as:

V_{dr,k}=A_{dr,k}^{dri}·e^{jφ}^{_{dr,k}}^{^{dri}}·V̆_{dr,k}

Improved DXHS adaptive algorithm:

$${{V}^{⌣}}_{dr , k} ( n ) = {A}_{dr , k} ( n ) \cdot sin [ {ω}_{r , k} ( n ) \cdot T \cdot n + {ϕ}_{dr , k} ( n ) ] \\ {A}_{dr , k} ( n ) = {A}_{dr , k} ( n - 1 ) + Δ {A}_{dr , k} ( n ) \\ {ϕ}_{dr , k} ( n ) = {ϕ}_{dr , k} ( n - 1 ) + Δ {ϕ}_{dr , k} ( n ) \\ Δ {A}_{dr , k} ( n ) = - {μ}_{r} \cdot {e}_{dr , k} ( n ) \cdot sin [ {ω}_{r , k} ( n ) \cdot T \cdot n + {ϕ}_{dr , k} ( n ) ] \\ Δ {ϕ}_{dr , k} ( n ) = - {μ}_{p} \cdot {e}_{dr , k} ( n ) \cdot cos [ {ω}_{r , k} ( n ) \cdot T \cdot n + {ϕ}_{dr , k} ( n ) ] \\ {ω}_{r , k} ( n ) = {ω}_{r , k} ( n - 1 ) + Δ {ω}_{r , k} ( n ) \\ Δ {ω}_{r , k} ( n ) = {μ}_{f} \cdot Δ {PH}_{dr , k} ( n ) \\ Δ {PH}_{dr , k} ( n ) = ( 1 - λ ) \cdot Δ {PH}_{dr , k} ( n - 1 ) + λ \cdot {Δϕ}_{dr , k} ( n ) \\ Wherein {e}_{dr , k} = {\hat{V}}_{dr , k} - {V}_{dr , k} = ( {\hat{I}}_{coil , k} - {I}_{coil , k} ) ( {R}_{c} + {SL}_{c} ) \\ {\hat{I}}_{coil , k} = {\hat{I}}_{coil , k}^{′} + {\hat{I}}_{coil , k}^{″} \\ {\hat{I}}_{coil , k} = \frac{{v}_{a , k}}{{C}_{e} Bl} ( {m}_{a} {ω}_{n , k} - \frac{{k}_{a}}{{ω}_{n , k}} ) \cdot {e}^{j {ω}_{n , k}} \\ {\hat{I}}_{coil , k}^{″} = \frac{{v}_{a , k}}{{C}_{e} Bl} ( {c}_{a} - 2 {ξ}_{k} \sqrt{{k}_{a} ( {m}_{a} - \vert {Δ}_{k}^{′} \vert / {ω}_{n , k} )} ) \\ \vert {Δ}_{k}^{′} \vert = {m}_{a} {ω}_{n , k} - \frac{{k}_{a}}{{ω}_{n , k}} \\ {ω}_{n , k} = \frac{{ω}_{r , k}}{\sqrt{1 - 2 {ξ}_{k}^{2}}}$$

The measured latency Δtₛₑₙₛₑ, the control algorithm latency Δt_{control} and the driving phase shift Δφ_{dr} all have an effect of phase shift on the absorption control algorithm. The novelty and advantages of the improved DXHS adaptive control algorithm can automatically adjust to compensate for the effect of phase shift.

### DESCRIPTION OF THE PREFERRED EMBODIMENTS

In the following embodiments, the specific implementation details for system configuration requirements, system parameter correction, startup of the virtual resonator, acquisition of the signal spectrum to be absorbed, system application scenarios, and key steps of absorption method are described as below:

1. System Configuration Requirements

a). Absorptive Capacity Analysis
Let the maximum disturbance pressure that the absorber expects to absorb be pₘₐₓ. Also suppose that the maximum electromotive force that the absorber can provide is F_{elc}^{max}, to make the absorber absorb the vibration caused by the disturbing force, it must satisfy F_{elc}^{max}>Sₐ·pₘₐₓ
That is,

$${I}_{coil}^{max} > \frac{{s}_{a} \cdot {p}_{max}}{{C}_{e} Bl}$$

Suppose the nominal power and pressure sensitivity of the absorber are Wᵣₐₜₑ and SPL_{1w} respectively, and the maximum absorbable pressure level is:

SPLₘₐₓ=20·log₁₀[pₘₐₓ/p_{ref}]
wherein

$${p}_{ref} = 2 \times {10}^{- 5} Pa$$

$${SPL}_{max} = {SPL}_{1 w} + 3 \cdot {log}_{2} {W}_{rate}$$

$${p}_{max} = {10}^{\frac{{SPL}_{max}}{20}} \cdot {p}_{ref}$$

The maximum pressure of the absorber obtained from the above formula should be verified by testing.

b). Requirements for Sensing Module and Driving Module
The current measurement latency and voltage measurement latency of the sensing module should be as close as possible, and as small as possible. The driving latency of the driving module should also be as small as possible, and the relationship between phase shift and signal frequency be as smooth and consistent as possible.

c). Selection of the Controller
Select a processor with real-time computing capability and sufficient computing capacity as the central processing component of the controller, such as Field-programmable gate arrays (FPGA) and system-on-chip (SOC)s.

2. System Parameter Correction

a). Coil Electrical Parameters R_{c}, L_{c}
From the initial state of the coil zero current and zero voltage, apply a constant coil voltage V_{dr}. After the coil current I_{coil} stabilizes, measure V_{dr} and I_{coil}, then obtain R_{c}=V_{dr}/I_{coil}. After obtaining R_{c}, apply the constant coil voltage V_{dr} from the initial state of the coil zero current voltage. For the initial stage of applying the constant coil voltage, I_{coil} is relatively sufficiently small, there is below relationship:

$${L}_{c} = ( \frac{{V}_{dr}}{{I}_{coil} ( t )} - {R}_{c} ) t$$

R_{c}, L_{c} can be obtained by impedance analyzer.

b). Coil Electromagnetic Parameters CₑBl
First, place the absorber on a rigid non-vibration platform, and use the accelerometer method or the dual-microphone reflection method to measure the relative velocity νₐ of the actuator. Since the sensing module can directly measure V_{dr} and I_{coil}, the parameters can be written as:

$${C}_{e} Bl = \frac{{V}_{dr} ( s ) - {I}_{coil} ( s ) ( {R}_{c} + S \cdot {L}_{c} )}{{v}_{a} ( s )}$$

c). Actuator Resonant Frequency ωᵣ
To use a driving firmware to short the two ends of the coil to Ground, there are:

$${F}_{e} ( s ) = {C}_{e} Bl \cdot {I}_{coil} ( s ) = \frac{- {C}_{e} Bl \cdot {C}_{d} Bl}{( {R}_{c} + {SL}_{c} )} {v}_{a} ( s )$$

$$( {m}_{a} S + {c}_{a} + \frac{{C}_{e} Bl \cdot {C}_{d} Bl}{( {R}_{c} + {SL}_{c} )} + \frac{{k}_{a}}{S} ) {v}_{a} ( s ) = {F}_{p} ( s )$$

Then to use a frequency generator to generate test excitation signals to find the resonant frequency ωᵣ corresponding to the maximum resonant velocity νₐ. Wherein, νₐ can be calculated by the coil current:

$${v}_{a} = \frac{- {I}_{coil} ( {R}_{c} + S \cdot {L}_{c} )}{{C}_{d} Bl}$$

d). Actuator Damping Ratio ξ
First, use a driving firmware to short the two ends of the electromagnetic coil to ground; second, the pressure amplitude pₐ acting on the actuator is measured by a pressure sensor. Since the velocity of the actuator is:

$${v}_{a} = \frac{- {I}_{coil} ( {R}_{c} + S \cdot {L}_{c} )}{{C}_{d} Bl}$$

Therefore, the damping ratio can be calculated by the following formant ratio:

$${M}_{r} = \frac{1}{2 ξ \sqrt{1 - {ξ}^{2}}} = \frac{{v}_{a} ( s ) \cdot {k}_{a}}{{ω}_{r} {p}_{a} {A}_{s}}$$

e). Sensing Latency Difference Δtₛₑₙₛₑ
Define Δtₛₑₙₛₑ as the difference between the coil voltage sensing latency and the coil current sensing latency.
First, attach a relatively large mass object to the moving part of the actuator and then apply a relatively small driving voltage V_{dr}. For this situation, E_{d}(s) can be approximated to zero, and the latency equations can be written as:

V_{dr}(s)=I_{coil}(s)(R_{c}+SL_{c})

e^{-j(φ}^{_{dr}}^{^{sen}}^{-φ}^{_{coil}}^{^{sen}}⁾· [symbol] = [symbol] ·(R_{c}+SL_{c})

e^{-j(Δt}^{ₛₑₙₛₑ}^{/ω}^{ₑ}^{)·} [symbol] ⁼ [symbol] ^{··(R}_{c}+jωₑL_{c})

The sensing latency difference Δtₛₑₙₛₑ can be obtained by the above formula, where [symbol] is the measured coil voltage, [symbol] is the measured coil current, and ωₑ is the excitation frequency. Parameters [symbol] , [symbol] and ωₑ can be measured.

3. Startup for Virtual Resonator

The startup process of the virtual resonator is as follows:
a). First, to obtain resonant frequency ωᵣ and damping ratio ξ for the virtual resonator to start operating;
b). To apply an electromagnetic excitation force with the resonant frequency of ωᵣ, apply an electromagnetic coil excitation voltage V_{dr}ⁱ. The amplitude of which is from zero initial value and is sufficiently slow increased;
c). Use the measured values of the electromagnetic coil current and voltage to calculate the velocity νₐ of the actuator;
d). Calculate the resonant frequency adjustment current I′_{coil} and damping ratio adjustment current I″_{coil,k}, according to the velocity νₐ of the actuator, and then obtain the corresponding coil adjustment voltage V′_{dr} and V″_{dr};
e). Apply the total control regulation voltage V_{dr}=V_{dr}ⁱ+V′_{dr}+V″_{dr} to generate a working virtual resonator;
f). Based on the latest velocity νₐ of the actuator, adjust the electromagnetic excitation voltage ν_{dr}ⁱ, such that νₐ is allowed in the specified range;
g). After the velocity νₐ of the actuator oscillates stably, the starting process of the virtual resonator is completed.

4. Acquisition of Spectrum to be Absorbed

The steps of using the virtual resonator's resonant frequency scanning method to obtain the spectrum of the signal to be absorbed are:
a). Select the lowest frequency of the signal to be absorbed as the initial scanning frequency of the virtual resonator;
b). After the virtual resonance occurs and stabilizes, record the coil excitation voltage V_{dr,0}ⁱ, the velocity of the actuator ν_{a,0}, and resonant frequency ω_{r,0};
c). Stop applying coil excitation voltage V_{dr,0}ⁱ, resonant frequency adjustment voltage V′_{dr,0}, and damping ratio adjustment voltage V″_{dr,0}, then the virtual resonance will be stopped;
d). Select the next frequency scanning point to startup a virtual resonance. When the virtual resonance is stable, record the coil excitation voltage V_{dr,k}ⁱ, the velocity of the actuator ν_{a,k}, and the resonant frequency ω_{r,k}, then stop the virtual resonance;
e). Continue select next frequency scanning point and repeat the above step until the highest absorption frequency;
f). Calculation of the signal spectrum:

$$( {m}_{a} S + {c}_{a} + \frac{{k}_{a}}{S} ) {v}_{a} ( s ) = {F}_{i} ( s ) + {F}_{ω} ( s ) + {F}_{ξ} ( s ) + {F}_{p} ( s )$$

$$( {m}_{a}^{′} S + {c}_{a}^{′} + \frac{{k}_{a}}{S} ) {v}_{a} ( s ) = {F}_{i} ( s ) + {F}_{p} ( s )$$

Resonant peak ratio:

$${M}_{r} = \frac{1}{2 ξ \sqrt{1 - {ξ}^{2}}} = \vert \frac{{v}_{a} ( s ) \cdot {k}_{a}}{{ω}_{r} ( {F}_{i} ( s ) + {F}_{p} ( s ) )} \vert$$

K^{th} order resonant peak ratio:

$${M}_{r , k} = \frac{1}{2 {ξ}_{k} \sqrt{1 - {ξ}_{k}^{2}}} = \vert \frac{{v}_{a , k} ( s ) \cdot {k}_{a}}{{ω}_{r , k} ( {F}_{i , k} ( s ) + {F}_{p , k} ( s ) )} \vert$$

Given known ξₖ, ν_{a,k}, kₐ, ω_{r,k}, and F_{i,k}, from the above formula, F_{p,k} (s) can be) calculated, which is a point in the signal spectrum.

5. System Application Scenarios

a). Vibration Absorption Application
When applying invention to absorb vibration signals, for objects to be absorbed, typical application examples include tube wall of air conditioners or a casing of power equipment. The vibration absorbing actuator can be installed both inside and outside the tube wall of air conditioners or the casing of power equipment. Inside installations may not require more space, but may be difficult to maintain. Outside installations may require more space, but is easy to maintain. For vibration absorption applications, a loudspeaker or an actuator functionally equivalent to a loudspeaker can be used as an actuator of vibration absorber, and the method needs to determine required actuator power, frequency spectrum range, number of actuators, and location of actuators according to specific vibration absorption requirements. The vibration source causes the base of the actuator to vibrate, so that the moving part of the actuator moves relative to the base of the actuator.
For a specific application, selection of vibration absorption capacity of the actuator can be determined by the calculation method and experiment method. The calculation method requires the stiffness and mass distribution of the object to be absorbed. After measuring the motion of different measuring points of the object to be absorbed, the equivalent disturbance force on the measuring point can be obtained by calculation. The number of vibration actuators and its distribution should satisfy that the maximum vibration displacement caused by multiple distributed vibration actuators for any point on the object to be absorbed is greater than maximum vibration caused by the maximum disturbance force excitation in the case of no vibration actuators, and within the disturbance frequency range. The experimental method is to select different actuator powers, different numbers of actuators, and different actuator distributions, and a combination thereof that meets the above requirements.

b). Sound Absorption Application
When applying invention to absorb sound signals, a typical application example is to absorb sound in cab or power machine room. For implementation of this type of sound absorption system, a loudspeaker or an actuator functionally equivalent to a loudspeaker can be used as actuator of sound absorber. The power rate of the actuator, spectrum range of sound absorption, number of the actuators, arrangement of the actuators and its orientation should be determined according to the specific requirements of sound absorption application.
Similar to above vibration absorption application, this design configuration of sound absorption system can also be carried out by the calculation method and experiment method. The calculation method requires the intensity and distribution of the sound to be absorbed. The number of sound absorbers and its distribution should satisfy that, in the case of no disturbance and within the disturbance frequency range, the maximum sound pressure caused by multiple distributed sound absorbers, at any point on the range of the sound absorption area, is greater than sound pressure caused only by the excitation of the largest disturbing sound source without any sound absorber. The experiment method is to select different sound absorber power, different number of sound absorbers, and different sound absorber distribution, and a combination thereof that meets above requirements.

6. Key Steps of the Absorption Method

The vibration and sound absorption method of the invention adjusts the resonant frequency and damping ratio of the actuator by controlling and I′_{coil} and I″_{coil}, to obtain a bandpass filter with adjustable center frequency and bandpass width, equivalent to a Helmholtz resonator with adjustable parameters. After completing the system configuration and parameter correction, the system is ready to perform vibration or sound energy absorption. The key steps of the energy absorption mainly include the following three aspects:

a). Determining Absorption Frequencies
First, use the resonant frequency scanning method with the virtual resonator to obtain a spectrum of signals to be absorbed, and then determine the frequency of absorption and the number of the absorption frequencies.

b). Determining Absorption Damping Ratio
Before the signal to be absorbed causes the virtual resonator to resonate, set the damping ratio to be smaller, so that the signal to be absorbed can excite the virtual resonator resonance as quickly as possible. After the virtual resonator resonance occurs, adjust the absorption damping ratio, such that the resonant velocity of the actuator is within the allowable range. On the other hand, it is necessary to adjust the resonant velocity of the actuator to be as high as possible, as the greater the resonant velocity of the actuator, the more energy will be absorbed.

c). Tracking of Frequency Disturbance or Drift
The adaptive control algorithm in this method has frequency tracking capabilities for a disturbance of frequency. In addition, the resonant frequency of the virtual resonator can also be adjusted by comparing the difference between the resonant frequency and the frequency corresponding to the measured or calculated maximum velocity peak.

What is claimed is:

1. An active vibration or sound absorption method with virtual resonators exclusively using sensing coil's current and voltage, including an actuator, a sensing module of coil's current and voltage, a controller, and a driving module, to control coil current's phase to be orthogonal to velocity's phase of the actuator to adjust the resonant frequency in the actuator, such that a signal to be absorbed causes a resonance in the actuator to form the virtual resonator.

2. The method according to claim 1, furthermore, the controlled electromagnetic coil's current is divided into two parts, where phases are orthogonal to each other, one of which is orthogonal to actuator velocity's phase, configured to adjust resonant frequency of the actuator, while the other of which is in phase or antiphase with the actuator velocity's phase, configured to change a resonant damping ratio of the virtual resonator.

3. The method of claim 2, wherein, while applying the coil control current for adjusting resonant frequency, needs to impose an excitation voltage to the electromagnetic coil with the same resonant frequency to start a virtual resonator to work as expected.

4. The method of claims 2 and 3, furthermore, in order to maximize energy absorption, it is necessary to adjust resonant damping ratio of the virtual resonator, such that the actuator's velocity reaches the maximum within an allowable range.

5. The method of claims 2, 3 and 4, furthermore, one actuator can generate multiple virtual resonators simultaneously, to absorb energy of signal harmonics with different frequencies, and the resonant frequency and damping ratio for each virtual resonator can be adjusted independently.
